(19) United States
(12) Patent Application Publication
(10) Pub. No.: US 2002/0080446 A1
(43) Pub. Date: Jun. 27, 2002

(54) Optical switch and method of switching optical signals

(76) Inventors: Stylianos Derventzis, North York (CA); Steve Hill, Toronto (CA); Blaine Hobson, King City (CA); Ali Langari, Scarborough (CA); Mike Liwak, Pickering (CA); Robert B. Thayer, Painted Post, NY (US)

Correspondence Address: Daniel A. Scola, Jr., HOFFMANN & BARON, LLP, 6900 Jericho Turnpike, Syosset, NY, 11791, US

(21) Appl. No.: 09/988,877

(22) Filed: Nov. 21, 2001

(30) Foreign Application Priority Data
Jul. 26, 2001 (CA) 2,354,446
Nov. 22, 2000 (CA) 2,326,800

(51) Int. Cl. G02B 6/26; G02B 6/42; H04J 14/02

(52) U.S. Cl. 359/128; 385/16

(57) ABSTRACT

A method and apparatus for switching DWDM optical signals through N switch ports. The optical switch includes N bidirectional signal processors including at least one associated with each of said N switch ports. The signal processors split and combine optical signals so that an optical signal passing in one direction through any one of the bidirectional signal processors is split into K parallel optical signals. One or more optical signals passing through any one of the bidirectional signals in the other direction are emitting as a single optical signal. The splitting direction is oriented into the switch. At least K signal delivery matrices are provided each signal delivery matrix having N matrix ports and broadcasting one of said K optical signals from any one of said N matrix ports to all other of said matrix ports. A plurality of bidirectional signal selectors are also provided at least one located between each of the bidirectional signal processors and a respective of matrix port to manage the optical signals being broadcast through the switch between the N switch ports. The signal selectors select or deselect one or more signal components from each of the K optical signals. A method of switching is also comprehended.

### FIELD OF THE INVENTION

This invention relates generally to the field of signal communication and more particularly to the field of optical signal-based communication systems. Most particularly, this invention relates to optical signal switching or cross connecting in optical-based information and data communication systems.

### BACKGROUND OF THE INVENTION

Optical signals are now used extensively in signal communication systems to carry digital information. Through the use of Dense Wavelength Division Multiplexing (DWDM) vast amounts of information can be densely packed onto optical signals, which make the use of such signals highly desirable. DWDM means that a large number of individual wavelengths (at present about 40 to 80 over each of the C and L bands) can be simultaneously used to carry data in a single fiber as multiplexed signal components.

At present optical signal networks typically take the form of large rings or hubs, which might be connected by a long haul or ultra long haul connection. These rings are cross connected to smaller local rings, which may in turn be connected to even smaller rings within a very localized area all of which is typically based on Synchronous Optical Network (SONET). At each connection between the various rings the appropriate optical signals must be directed or routed in the appropriate direction. At present these connections are made by optical-electrical-optical (OEO) switches or cross connects, which require that the optical signal be converted to an electrical signal, routed, reconverted to an optical signal and then sent on its way.

Essentially what is required is an ability to route individual information or data carrying wavelengths or signal components in particular directions according to the intended destination of the information. The same wavelength or channel may be used to carry many different pieces of information having the same or different intended destinations. Most desirably information carried by the specific wavelength or signal component should be routed according to the information being carried and its intended destination. At present, the routing of signals requires an OEO process in which an optical signal is converted to an electrical signal, routed electronically, and then converted back into an optical signal again for delivery to the new destination which can create a bottleneck. The bottleneck gets more severe as both data rates and the number of DWDM channels increase. This equipment is also expensive.

Using DWDM means that a single fiber can carry multiple wavelengths. Carrying multiple wavelengths increases the need for a reliable cross connect and increases the needed capacity in the cross connect. The use of DWDM technology means that such cross connects must have enough capacity in the future to be able to -connect together hundreds of wavelengths to benefit from the greater signal carrying capacity per fiber that DWDM provides. Because of the large number (likely more than noted above in the future) of wavelengths on each fiber, and the large number of fibers in a bundle, cross connecting represents an ever more critical (as data flow increases) bottleneck in the transmission of data through optical networks and transmission systems. In metro systems the need for more connections which typically have lower data rates as compared to long haul means there is a need for low cost switching solutions.

A number of strategies have recently been proposed to overcome the current switching bottleneck. In one strategy, sophisticated management software is used in an OEO switch to automate the setting up and tearing down of wavelength connections. However, such systems, while flexible, are not keeping up with the increases in bandwidth at the speed required. Further even when it is possible to route more bandwidth, the expense can be enormous. Another strategy that has been suggested is to use an all optical connection which eliminates the electrical interface. For example, an optical switch has been proposed which uses Micro-Electro-Mechanical Systems (MEMS) such as arrays of tiltable tiny mirrors that are tilted or translated to direct the optical signals passing into the switch through an input plane to first one then to another output port across the body of the switch on an output plane. MEMS are still cumbersome and relatively slow to switch between output ports, on the order of 50 milliseconds or even less. Also, there is some question of whether the tiny mirrors will reliably function over time, due to electro-mechanical failure such as stiction. As larger MEMS arrays are used system alignment becomes critical.

Another strategy recently suggested is to use the surface of tiny bubbles to redirect light onto new paths for switching purposes. Questions remain as to the stability of the bubbles' structures over connection lifetimes. Scaling up this technology to meet the increasing cross-connect demands is limited due to the strict 1 to 1 link and blocking nature of the switch, similar to the limitations of planar MEMS.

While providing for a more optically based apparatus than the conventional OEO systems, both of the MEMS and bubble reflecting systems require that the signal be separated into individual wavelengths to accomplish the switching and routing of any optical signal. This is cumbersome because for each additional signal channel, another connection is required and as the bandwidth expands the number of connections inside the switch becomes enormous. For example, for a 1 to 1 connection with 4 input fibers and 4 output fibers carrying 60 signals per fiber requires at least 240 independent controlled mirrors or bubbles.

What is desired is a high speed switch for allowing signal components to be effectively and flexibly routed, which does not require the use of MEMS or other structures requiring strictly a 1 to 1 connectivity, which does not require the OEO conversion and which offers rapid switching of wavelengths to various output ports according to their intended destination. What is also desired is an ability to add capacity to an existing installation to increase the number of fiber connections and/or the number of wavelengths that can be routed.

### SUMMARY OF THE INVENTION

An all optical switch according to the present invention can be provided which overcomes the limitations of the prior art and is flexible in routing. According to the present invention there is provided an optical switch having N switch ports for switching optical signals, said optical switch comprising:

N bidirectional signal processors for splitting and combining optical signals, wherein an optical signal passing in one direction through any one of said bidirectional signal processors is split into K parallel signals and wherein one or more optical signals passing through any one of said bidirectional signal processors in the other direction are emitted as a single optical signal, said one direction being oriented into said switch and said other direction being oriented out of said switch;

K signal delivery matrices, each of said signal delivery matrices having N matrix ports and broadcasting one of said K optical signals from any one of said N matrix ports to all other of said N matrix ports; and

a plurality of bidirectional signal selectors, at least one located between each of said N bidirectional signal processors and each of said N matrix ports to manage the optical signals being broadcast through said switch between said ports by selecting or deselecting one or more signal components from each of said K optical signals.

According to a further aspect of the present invention each of said K signal delivery matrices comprises:

a symmetrical signal splitter having three connections associated with each of said N matrix ports wherein an input signal received by any one connection is split into two equal and parallel signals one of each of which passes out of said symmetrical signal splitter through the remaining two connections, and

a means for bidirectionally amplifying optical power interposed between each of said symmetrical splitters for boosting a power of each of said split signals as said split signals pass through the optical power amplifier to get to the next port sufficiently to substantially equal a power of an input signal received by said symmetrical splitter.

According to a further aspect of the present invention each of said K signal delivery matrices comprises:

N second bidirectional signal processors for splitting and combining optical signals, wherein an optical signal passing in one direction through said bidirectional signal processors is split into (N−1) parallel signals and wherein one or more optical signals passing through said bidirectional signal processor in the other direction are emitted as a single signal, said one direction being oriented into said matrix and said other direction being oriented out of said matrix;

an optical connection for each of said (N−1) signals between each of said second bidirectional signal processors and each other port; and

a power amplifier associated with said switch to amplify a power of the optical signals being switched by a predetermined amount.

According to a still further aspect of the invention there are provided in said switch first and second bidirectional signal selectors for each of said K signals for each of said N ports and an optical signal circulator connected between each pair of bidirectional signal selectors and said N signal processors, said optical signal circulator having at least three points of connection and circulating an optical signal received at one connection point out of the next adjacent connection point on said circulator, and wherein said signal delivery matrices further comprise a bidirectional broadcast coupler having a first side and a second side, each side having N connections, one each of said connections on said first side being connected to one first signal selector of each of said pair of signal selectors and one each of the connections on the second side being connected to one second signal selector of said pair of signal selectors, wherein an optical signal passing from either side of said bidirectional broadcast coupler to the other side of said bidirectional broadcast coupler is split into N parallel signals each of which is passed to each of said N ports through a respective signal selector.

According to a further aspect of the present invention there is provided a method of switching optical signals through a switch having N switch ports comprising the steps of:

a) receiving a signal at one of said N switch ports; and then

b) dividing said received signal into K informationally identical signals; and then

c) selecting or deselecting signal components from one or more of said K like signals; and then

d) providing said selected signal components to at least one other of said N switch ports; and then

e) combining said selected signal components with other selected signal components received at said one other of said N switch ports; and then

f) emitting said combined selected signal components from said one other of said N switch ports.

### BRIEF DESCRIPTION OF THE DRAWINGS

Reference will now be made to various figures which show, by way of example only, preferred embodiments of the invention and in which:

FIG. 1 shows a general architecture for an optical switch according to the present invention;

FIG. 2 shows a first embodiment of the present invention according to the general architecture of FIG. 1;

FIG. 3 shows a second embodiment of the present invention according to the general architecture of FIG. 1;

FIG. 4 shows a third embodiment of the present invention according to the general architecture of FIG. 1;

FIG. 5 shows a schematic of a signal selector of one type suitable for the present invention;

FIG. 6 shows an algorithm of a control system of a type suitable for use according to the present invention; and

FIG. 7 shows a system diagram for an optical signal processor or splitter/combiner suitable for use with the present invention.

### DETAILED DESCRIPTION OF THE PREFERRED EMBODIMENTS

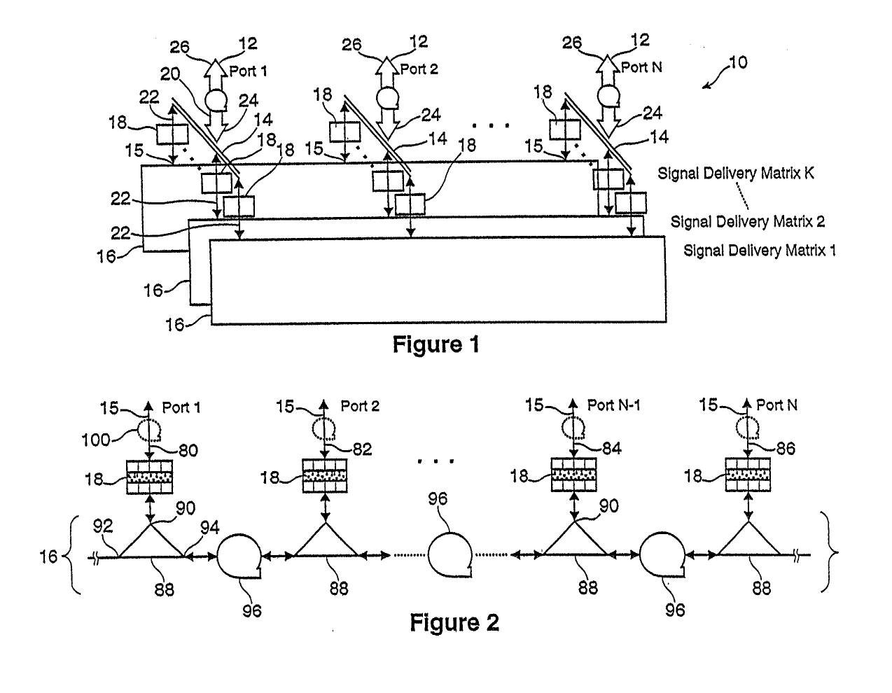

An optical signal processing architecture for a preferred form of switch according to the present invention is shown as 10 in FIG. 1. It will be appreciated by those skilled in the art that the term “switch architectures” as used in this disclosure means a configuration of components which in combination provide the optical signal switching or routing functions as set out more fully below. In this disclosure, the term switch includes, but is not limited to, a device which is generally capable of directing optical signals and optical signal components, such as individual wavelengths or channels as needed and comprehends routing functions such as pure switching as well as add/drop functions and the like. Further, the term signal means an optical signal which may be for example a DWDM optical signal which includes one or more individual signal components, such as wavelengths or channels.

The optical signal processing architecture for the switch or router of the present invention is comprised of a number of elements having specific functions as set out more fully below. The preferred elements include a number of switch ports 12, at least one optical signal processor 14 associated with each switch port 12 at one end and being associated with a matrix port 15 at the other end, a plurality of signal delivery matrices 16 extending between all of the matrix ports 15 and a plurality of bidirectional signal selectors 18, one of which may be located, for example, at each matrix port 15. Each of these elements is described in more detail below.

The term port as used in this specification means any type of connection which permits an optical signal carrier to be connected in such a way so as to establish a signal path into or out of any given component. The most preferred form of switch port 12 is one which permits an optical signal carrier such as a fiber optic cable to be securely connected to the switch to establish an optical signal path from the fiber optic cable into the switch. The form of the matrix port 15 can vary and can be quite simple, provided the optical signal reliably passes into the signal delivery matrix 16.

According to the present invention the number of matrix ports 12 can be varied to suit the individual requirements of the switching or routing application. Thus, in a generalized architecture as shown in FIG. 1 switch ports 12 one and two are shown, and the switch is shown to be capable of having up to N ports. Thus, the switch of the present invention may include as many ports as may be needed, but most commonly between 3 and 20 switch ports 12 will be sufficient. Thus, the switch 10 can be considered to have N ports, where N is any whole number greater than one.

The next element in the switch architecture 10 of FIG. 1 is an optical signal processing element 14 which splits or combines optical signals passing through it. In one direction (from the switch port 12 to the matrix port 15) the signal processor 14 splits the signals into K informationally identical copies and in an opposite direction (from the matrix port 15 to the switch port 12) the signal processor 14 combines the K or less optical signals into a single signal. The absolute value of K will vary depending upon the switch requirements for multicasting, bidirectionality, redundancy and desired bandwidth. In this specification in a preferred embodiment K is set, by way of example only, at N/2. In the event N is an odd number N/2 is rounded down to the next lowest integer (i.e. for N=5; K=2.5 becomes K=2). However, K could also be any number up to and even exceeding N as desired. Thus whether the signals are split or combined depends upon the direction the signal is passed through the optical signal processor 14. Further, since optical signals can pass through the signal processor in either direction, the signal processor may be considered to be bidirectional, even though different results occur when passing through in one direction as compared to the other. Such splitting/combining can be accomplished either simultaneously, or sequentially depending upon the circumstances.

It will be noted that each switch port 12 has shown a single associated optical signal processor or splitter/combiner 14, but in some embodiments of the invention more may be used. The purpose of the signal processor 14 is to split an optical signal 20 into a plurality of signals 22 in one direction and to combine a plurality of signals 22 into one signal 20 in the opposite direction. In this sense the term split means to divide into a plurality of informationally identical or copied signals and does not mean to demultiplex. It will be appreciated that depending upon the type of splitter used, properties other than the information content can be varied, such as the power. As an example, if an input optical signal having a power of 1 was passively divided into K identical signals each of the K signals would have a power of 1/K (assuming no losses through the splitter element). It will be understood that the present invention also comprehends active splitters 14, which would also provide an optical power amplification to permit each of the copied (informationally identical) signals to be at full power. Thus according to the present invention each of the informationally identical divided or copied signals is still a multiplexed signal having all of the signal components of every other divided signal, but not necessarily at the same power.

The signal processor 14 is most preferably oriented so as to split or divide signals passing into the switch 10 and to combine separate signals into a single signal exiting or on the way out of the switch 10. For ease of understanding arrowheads 24 show a signal traveling into the switch and arrowheads 26 show a signal passing out of the switch. Most preferably therefore, the signal processor 14 is a bidirectional signal processor which divides a signal 20 being passed into switch 10 into a number, such as K, informationally identical copies or split signals 22 and combines signal components into signals in the reverse direction.

The next element of the switch 10 according to the present invention is the signal delivery matrix 16. The purpose of the signal delivery matrix 16 is to broadcast a signal emanating from one matrix port 15 to all other matrix ports 15. In this sense the term broadcast means directing a signal from one to many. Thus, the signal delivery matrix 16 is connected by an optical path which extends to all of the matrix ports 15. To permit a signal from any one port to reach all the other ports, it is appreciated that the signal delivery matrix is preferred to function to deliver signals and signal components in either direction across any connection. Thus, for example, a signal may be passed from port 1 to port 2 or from port 2 to port 1. In this sense the signal delivery matrix 16 is also bidirectional. Again, the signals may be either simultaneously transmitted or sequentially transmitted.

In some embodiments of the present invention optical signals will be transmitted in a way that maintains their signal properties, such as power, regardless of which way the signals are passing through the signal delivery matrix 16. In other embodiments as described below the amplification of the optical signals can be done outside of the matrix 16 and the gain of the amplification set to compensate precisely for any power losses within the signal delivery matrix 16.

As shown in FIG. 1, each of the input signals at the N switch ports is split into K copies and according to the present invention there is preferably a signal delivery matrix 16 for each of the K copied signals split out from an input signal by the signal processor 14. According to the present invention there are at least three configurations or architectures for the signal delivery matrix 16, each of which is explained in more detail below. However, the present invention is not limited to any of the specific architectures and comprehends other combinations of elements which provide the signal broadcast function as described herein.

Before referring to the overall switch architecture in any greater detail, it is important to understand some additional aspects of the present invention. One such aspect is the provision of a device which acts as a signal selector 18. This element is provided to manage the optical signals being broadcast through the signal delivery matrix. In simple terms the signal selector acts as a bidirectional gate (again either simultaneously or sequentially), which selectively selects signal components which are to be passed through the selector 18. It will be appreciated by those skilled in the art that the selection of one or more signal components from a multiplexed signal means that other signal components are thereby deselected from any further transmission. Selected in this sense means enough of the signal component is transmitted through the selector to permit further manipulation of the signal component. Deselected means enough of the signal component is blocked, absorbed, deflected or dispersed so that further manipulation of the signal component is prevented. It will be further appreciated that many forms of signal selector are possible, including any of active switch means such as electro, magneto, acusto or thermo optical effects and any passive multiplexing/ demultiplexing means such as fiber, bragg grating, thin film filters, fused coupler filters, arrayed wave guide selector (AWG) and the like. The present description is of only one form which is presently considered to be the most preferred.

As shown in FIG. 1, at least one signal selector 18 is most preferably associated with each of said K signal outputs of said bidirectional signal processors 14 at each port. Thus, for a switch port having an input signal divided into K informationally identical signals or copies, K signal selectors are required. According to one preferred form of the present invention the signal selectors are bidirectional. In this sense bidirectional means that signals may pass through the signal selector into the signal delivery matrix 16 and may also pass out of the signal delivery matrix 16 through a signal selector 18. This permits the signal selector 18 to select or deselect signals either entering or exiting the signal delivery matrix 16 through the ports 15.

The number of signal selectors required is derived according to a simple mathematical formula. Specifically, in this embodiment, the number of signal selectors required is equal to or greater than the integer of (N/2) multiplied by N, where N is equal to the number of switch ports 12. Thus, when N equals 6, or for a switch having 6 switch ports then at least 6 times (6/2) or 18 signal selectors are required. As noted below more may also be required, as in one embodiment of the present invention twice this number of signal selectors are required.

As described above DWDM signals comprise a plurality of individual wavelengths multiplexed together. Each separate wavelength may be considered as a separate signal channel or signal component. The signal selectors perform the function of selecting one or more signal components to pass through into the signal delivery matrix, or to be permitted to be emitted out of the signal delivery matrix.

One preferred form of signal selector is to use AWG's as the multiplexing/demultiplexing elements, which straddle a signal selector device or means such as a VOA (Variable Optical Amplifier) or SOA (Silicon Optical Amplifier). In such a device, the multiplexed signal is first demultiplexed, as it travels into the device, then individual channels or signal components are switched (i.e. passed or blocked) and then pass through the second AWG to be multiplexed together again.

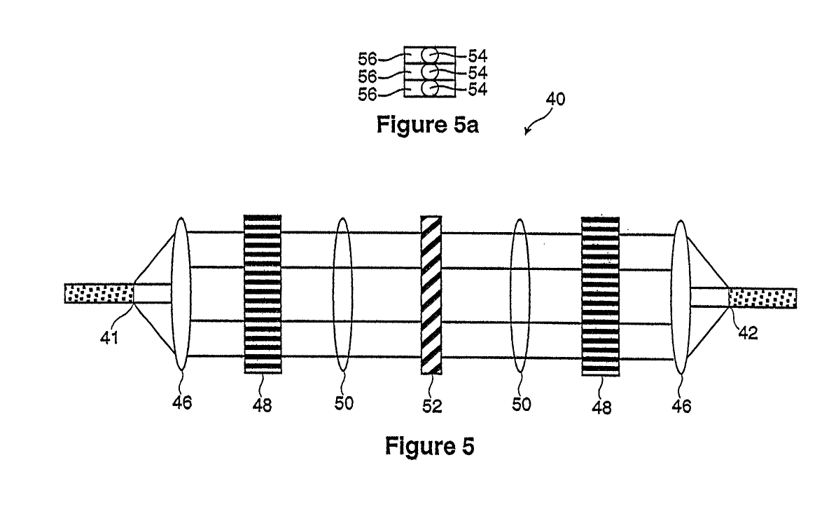

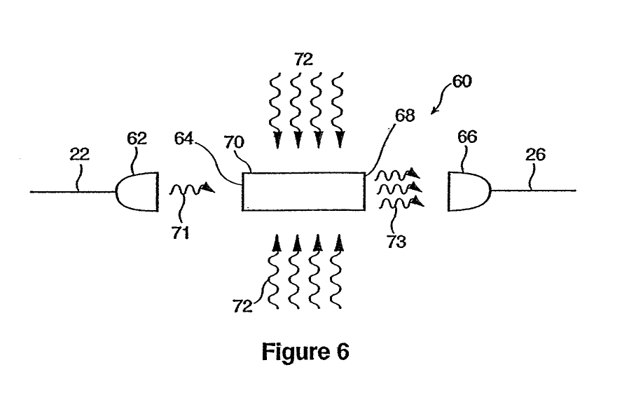

Another form of signal selector 18 according to the present invention is shown in FIG. 5 and indicated generally as 40. Since the signal is selected according to wavelengths, the device 40 may also be referred to as a lambda selector. The selector 40 is characterized by having two optical signal sources, such as optical fibers 38, 39 connected to ports 41 and 42. In this sense port means a coupler or connector which permits optical signals to reliably pass into and out of the device 40. Further, source comprehends any component which passes an optical signal into the device 40 such as a fiber, a lens, a splitter or other device. Since the selector 40 is preferably bidirectional, it accepts input optical signals at either of the two ports 41, 42. Any input optical signal passes along a predetermined signal path through the device 40 as will now be described. As described in more detail below, the bidirectionality of the lambda selector may occur simultaneously for the same or different signal components, or, may be sequential in time depending upon system configurations and needs.

The first element adjacent to both ports 41 and 42 is a collimating lens 46. As will be appreciated by those skilled in the art the collimating lens has the effect in one direction of converting a divergent beam path into a parallel or planar beam path. According to the preferred form of wavelength selector 40 the divergent beam is turned into a parallel beam as the signal is passed further into the device 40. For a signal passing in the opposite direction, the opposite effect occurs, namely a parallel beam is turned into a convergent beam.

The next element is preferably a means for multiplexing and demultiplexing such as a transmissive diffraction grating 48. It will be understood that other forms of multiplexer/demultiplexer can also be used such as transmissive gratings, arrayed waveguides, prisms and the like. This element 48 separates polychromatic light into its spectral content spatially by producing parallel beams of light each at a different wavelength. In the opposite direction it combines parallel beams of light of different wavelengths into polychromatic light. The separation into individual wavelengths occurs as the signal passes further into the selector 40. As will now be appreciated, the signal is now de-multiplexed after passing through the diffraction grating 48.

The next element in the lambda selector is a focusing lens 50 or system of lenses to direct the de-multiplexed wavelengths into a specific location in space. Again each of the lenses 50 acts in both directions.

The central element of the device 40 is an optical shutter array 52 of which there need only be one. The optical shutter is a means for selecting and deselecting signal components or wavelengths. This element comprises multiple optical shutters individually controllable, one located in each point in space corresponding to the location that each individual wavelength has been directed. This is shown schematically in FIG. 5a which is an end view showing a transmissive shutter window 54 surrounded by a mounting 56. The individual beams are focused onto individual windows 54. It will be appreciated that an operational relationship exists between the focusing lens 50 and the shutter array 52. The relationship is that the lens 50 controls, in the plane of the shutter array, the size, shape and physical location of each wavelength, and the individual shutters of the shutter array are located and sized to be directly in a path of each of said individual wavelength beams. The optical shutter array 52 in the preferred form has the ability to change opacity in rapid fashion for example, in response to an electrical signal, to selectively permit individual wavelength beams to pass through or to substantially block(i.e. deselect) the same. For example, an electro optic device such as PLZT could be used as a shutter.

It will be appreciated by those skilled in the art that other means for selecting and deselecting signals can be used. For example, the shutter could be used to adjust the polarization of the signal, which can then be selected on the basis of polarization. Other means of selecting or deselecting can also be used, but what is desired is a means which is rapidly operable to select and deselect signals, signal components or channels.

It will now be appreciated that the interaction between the selective switching of specific wavelengths of the optical signal by the shutter array 52 and the use of the focusing lens 50 permits the selector 40 to select or deselect individual wavelengths. Thus, individual wavelengths or signal components may be separated out from the multiplexed signal according to switching or routing requirements. Signals which have been deselected or blocked are not permitted to pass through the lambda selector. Signals which are permitted to continue are then recombined and passed to the other output port for further transmission.

According to the present invention it is preferred if both ports 41 and 42 are bidirectional, meaning that each port may be passing optical signals through the means for amplifying in both directions simultaneously. As will be appreciated by those skilled in the art, signals traveling in opposite directions will readily pass through one another without degrading the quality of any opposite traveling optical signal. In most cases however, it may be preferred to operate the device sequentially or to provide for separate simultaneous amplification paths. This would be desirable in the event there is any reflection of input signals or back directed Amplified Spontaneous Emissions (ASE) which could add to output signals being passed through the signal selector in the opposite direction. Thus, the present invention comprehends a switch which may have signals and/or signal components passing through elements in both directions simultaneously, and also comprehends a switch which has signals and/or signal components passing through in one direction only or first in one direction, then in the other direction, sequentially. Further the present invention comprehends permitting signals components to pass through in one direction but the same signal components being blocked in the other direction.

To facilitate the manipulation of optical signals it is preferred to have the signals at a predetermined power. Some of the components of the router according to the present invention discussed above have the effect of altering or reducing the power, such as the signal processor 14 which splits and combines the signals. Others introduce transmission losses such as the signal selectors. Generally it is desirable to have all signals leave the switch according to the present invention with approximately the same power as they arrived with, or more precisely, with the same power at which optical signals are provided within the optical network. This power level may be referred to as an operating power level. Thus, it is preferred according to the present invention to use a signal power amplifier as needed to boost the power signal so that the optical signals leaving the switch 10 will conform with operating power requirements. This is referred to as lossless switching or routing.

It will also be appreciated that the present invention comprehends a means for amplifying optical signals, such as a EDFA (Erbium Dobed Fiber Amplifier) or the like. Most preferably, the means for amplifying will permit amplification of signals in both directions through the amplifier. Amplification may be needed because of the signal power losses which can arise during the signal switching and routing. The amount of amplification needed will vary, and depends upon the configuration of the signal routing device.

Having described the above noted components which form the switch architecture, a switch having a broadcast configuration according to the present invention can now be understood.

FIG. 2 shows a first embodiment of a switch architecture according to the present invention which is referred to as a port to port replication type switch. In this example, a switch having a number of ports 12 is shown. It will be understood that the diagram of FIG. 2 represents one plane from the generalized architecture set out in FIG. 1 of the signal distribution matrix 16.

As shown, each port has a signal path indicated as 80, 82, 84 and 86 for port N. The signal paths are indicated with double ended arrows indicating that optical signals may pass in either direction either from or to the ports. Next is shown a respective signal selector 18 for selecting specific signal components to pass either into or out of the signal delivery matrix 16. It will now be appreciated that the signal selectors act as gates in both directions, managing the signals entering the signal delivery matrix as well as managing the signals exiting the signal delivery matrix at any given port.

The signal delivery matrix 16 in this embodiment comprises two components in combination. In particular, the signal delivery matrix includes a plurality of symmetrical splitters 88. These devices are characterized as ones which have three nodes, 90, 92 and 94 as shown. Thus, an input signal received at any node (say 90) will be split into two informationally identical signals one of which is sent out to each of the other two nodes (92 and 94). As can now be appreciated, for a passive splitter 14 this has the effect of reducing the power of each of the split signals, to approximately one half of the power of the input signal less internal power losses. Alternately, if an active or lossless splitter 14 is used there would be no change of power. Therefore associated with each passive symmetrical splitter 88 is a means for amplifying or power amplifier 96, which is tuned to deliver a predetermined amount of gain to raise the signal power to equal the input signal power. In this way, all signals input into any of the successive symmetrical splitters 88 will have the same power, because they will have been boosted by the interposed optical amplifiers 96. In this manner, any given signal can be communicated to all other ports at the same power as the power at which they started. Also shown is a second amplifier 100 which is optionally located outside of the signal selector. It will be appreciated by those skilled in the art that the preferred optical amplifiers of the present invention can be located at various points of the architecture as required to supplement the signal power as needed, depending upon the switch architecture. Any amplifier position will affect system performance including ASE (Asymmetrical Spontaneous Emissions) build up and signal to noise ratio degradation. The position of the amplifier must take this issue into account.

It can now be appreciated how the switch architecture of the first embodiment operates. A signal is received at port 1 and then is split into K identical, but lower power, signals. If there were no losses through the signal processor 14, the power of each of the K signals would be reduced to 1/K. In practice, there will be losses, but these losses can be managed by means of amplification as noted previously. The splitting of the input signal then provides an identical signal to input into K signal matrices. At each of the N ports, each of the K signals is then passed to a signal selector which is capable of selecting or deselecting any specific signal components from the multiplexed signal. All signals which have been selected are then communicated (broadcast) to every other port of the switch by passing through successive symmetrical splitters 88 and associated power amplifiers 96. The symmetrical splitters then ensure that the selected signal is delivered to every other port in the system and at the same power as when it entered the signal delivery matrix 16. In addition, at any given matrix port, the signal components can be either routed into the port, or not routed into the port by the bidirectional signal selector at that matrix port. Thus any given signal component can be selected at one matrix port and then delivered to any other matrix port and be permitted to exit at that matrix port. Thus the present invention provides that every signal can be presented to every other matrix port, because it is not known in advance at which switch ports any given signal is required. Once this is determined the signal components can be permitted to pass out of the matrix port 15; combined and passed out to the signal carrier through the switch port 12. Further, by providing K signal delivery matrices, signal mixing of the same wavelengths is avoided and yet enormous flexibility of signal routing is provided.

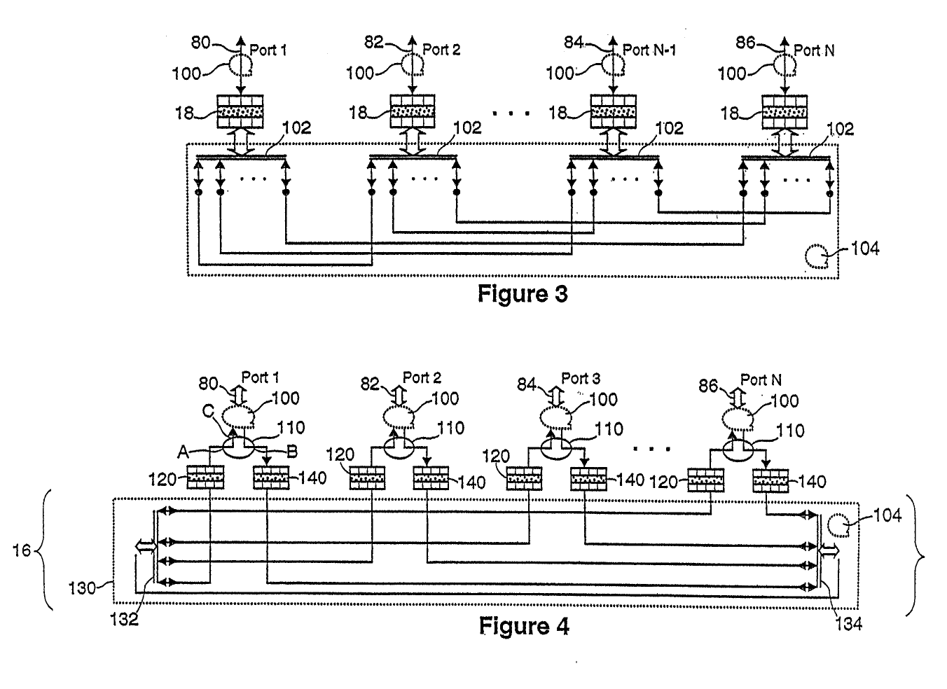

A second embodiment of the signal delivery matrix of the present invention is shown in FIG. 3. This embodiment is referred to as a direct replication type and like numbers refer to like components as in FIG. 2. Under this architecture, the signals are received coming into the port in the same manner and then one or more signal components are selected from the signal by a signal selector 18. Then the signals are passed through a second signal processor 102, which divides the selected signal into N−1 informationally identical signals, where N is the number of switch ports 12. The second signal processor 102 may be of the same type as 18 described above. Each of the N nodes of the second signal processor is connected by an optical pathway to a second signal processor associated with each of the other ports in the switch 10. Thus, each signal which is selected and passed into the signal delivery matrix is delivered to every other port. Thus, at each delivery port, a signal selector 18 will further select or deselect signals to permit the further selected signal or signal component to pass through and thus out of the port.

Again it is preferable to ensure that the signals being passed through the switch 10 have an even power. Thus, again there is preferably provided a power amplifier to boost the signal to ensure that the signals are uniform. To this end the power amplifier may optionally be provided in the signal connection between ports, or at any point between the port and the feed optical fiber into the switch as shown schematically by 104. Since the means for amplifying of the present invention is bidirectional and since it will only boost the power to a predetermined maximum, the amplifier could also be positioned on the input connection to the optical fiber at 100. However, system noise and thus performance is affected by amplifier position as noted above. Incoming signals may be amplified and outgoing selected signals may also be amplified and the total amplification or power gain can be set to any predetermined level, but most preferably will be set to a relevant operating power level before reentering the network from the switch 10.

A third embodiment of the signal delivery matrix of the present invention is now shown at FIG. 4 which may be referred to as a star replication type. In this embodiment there is shown an additional component, namely a circulator 110, associated with each switch port. A circulator 110 is a known device which may be considered to have three nodes or connection points indicated as A, B and C. It is characterized by being able to receive input signals at any connection point and then to pass the signals out at the next adjacent connection point on the circulator. The circulator 110 has the effect of dividing the signal path into an input signal path into the signal delivery matrix and an output path from the signal matrix, which are essentially in parallel. Associated with each of the input and output paths are an input signal selector 120 and an output signal selector 140. It will be appreciated that input and output are chosen for ease of reference and that either of the signal selectors 120, 140 could be either an input or an output selector. Most preferably the signal selectors are of the preferred type previously described.

The next element of this embodiment is a bidirectional broadcast coupler sometimes referred to as a star coupler. This coupler is shown schematically as 130 and essentially comprises a pair of back to back signal processors 132, 134 of the 1 to K splitter/combiner type such as previously described. In this manner every input signal selector is connected by an optical pathway to every output signal selector of every other node. It will be appreciated that two back to back signal processors are provided to permit all of the selected signals received in the signal delivery matrix 16 as outputs from the output signal selectors 140 to pass through a splitter so as to deliver to every other port the selected signals.

As can now be appreciated, the architecture according to the present invention is characterized in that for each embodiment, any signal can be directed or routed from any of the N ports to any one or more of the other N ports. Further, through the use of the signal selectors the routing can be changed at a rate equal to the switching speed of the selector element. To achieve such switching control, however, requires a control system for the switch, which is shown in schematic in FIG. 6.

Essentially the control system will receive signalling information from the network at 200, for example, by a control channel for this purpose. In addition the control system will have a set of desired signal properties 202 against which a set of measured signal properties 204 can be compared. The measured signal properties can include one or more of polarization, power, and wavelength of a given optical signal component for example and even polarization mode dispersion (PMD). In addition, an input into the control system may be optical headers 206 which are embedded or carried by the signal itself. All or some of these inputs are fed into the control system 208. As well, the control system 208 will rely on the switch characterization data shown at 210. Based on the foregoing inputs the control system 208 will change any controllable parameters as needed such as a gain of an optical amplifier or a condition of a particular signal selector to achieve a desired result shown as 212.

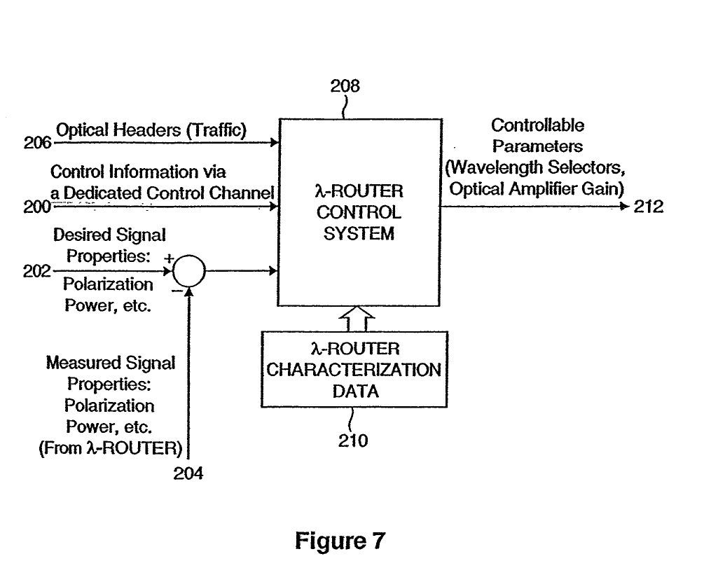

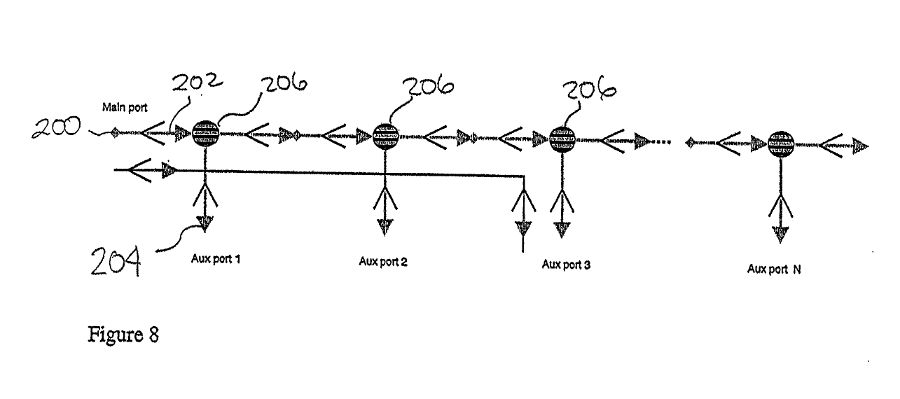

FIG. 7 shows a further aspect of the present invention. FIG. 7 shows schematically a lossless scalable splitter/combiner or replicator combiner. In FIG. 7 a main port is shown at 200, with a signal path 202 to an auxiliary port 204. These signal paths are formed by lossless couplers 206. A lossless coupler is desirable because it permits field installed additional connections within the switch to improve capacity. A lossless coupler 206 permits additional matrices to be added to the switch as more capacity is added to the signal in terms of additional signal components. Provided enough excess capacity is built into the lambda selector, additional signal component processing can be achieved, making the present invention field scalable. FIG. 7 describes a scalable structure by virtue of adding more couplers 206. Thus, over time, rather than replacing a whole switch to increase capacity, all that is required is to add further switch ports and associated matrix connections to achieve higher bandwidth capacity.

The switching of signals according to the present invention can now be described. First fibers will be connected to the switch, with a single fiber being connected to each of the switch ports. The number of ports can be set according to the connection demand of the location the switch is to be used in and a large number of optical fibers can be optically connected through the switch so as to permit a signal to pass from one fiber to another fiber. Once the fibers are connected, the control system is advised so that each connection is known and assigned.

The next step is to route or switch an inbound signal for example. The full multiplexed signal is passed into port 1. Then, the signal is split (or copied), and passed through a signal selector where the specific signal components are selected or deselected. The next step is to internally broadcast the selected signal components throughout the signal delivery matrix, in a way that permits the selected signal components to be delivered to each and every other matrix port. Then the selected signals are further selected or deselected to determine which if any signal components should be passed out through each port. In this sense, it will be understood that any fiber connection is a bidirectional connection with signals and signal components passing both into and out of the switch therethrough, again either simultaneously or sequentially.

As discussed above, the present invention preferably accomplishes this switching on an essentially lossless basis or even with net gain, meaning that an optical signal leaving the switch will be emitted at a predetermined power level. Most preferably, the power of the switched signals (i.e. the predetermined power level) will be set at a power value which is suitable for combining with optical signals at that position in the optical network.

It will now be appreciated that the present invention provides a switch architecture that enables frequency reusability within a given switch according to the present invention. For example, in a four port system, wavelength 1 can be routed from port 1 to port 2 and at the same time, wavelength 1 carrying different information can be routed from port 4 to port 3. Thus, much more capacity is added to the signal carrying network because the signal components can be used as needed in a point to point routing scheme.

It will also be appreciated that the present invention therefore permits the development of a unlimited cross-connection mesh network architecture for signal transmission networks, rather than a connected ring architecture as is presently used in the field although it can be used in a ring architecture also.

Another feature of the present invention is that the routing takes place at the trunk level. Although individual signal components are routed after being demultiplexed in the signal selector, multiple switching of the multiplexed signals takes place by virtue of the K signal delivery matrices. Switching takes place because K informationally identical copies of the signal components collectively or at the trunk level are used, rather than as in the prior art separating the signals into signal components and then producing copies of each signal component individually. Since a plurality of selected signals are broadcast throughout the signal delivery matrix at the same time, the routing of signals through the switch is both fast, efficient and significantly less costly per wavelength.

Further, an important advantage provided by the present invention is that the architecture is bidirectional as an overall structure. What is meant by this is that any signal received at any port can in fact be sent to any other port. Thus, unlike the MEMS cross-connect devices and the like currently being developed, the present switch invention is not limited to a defined set of input ports and a defined set of output ports. In the present invention most preferably any port can act as an input or an output port, even simultaneously for different signal components.

It will be appreciated by those skilled in the art that while the present invention has been described in relation to various preferred embodiments, there are other variations which may be made which do not depart from the broad scope of the invention as defined by the attached claims. Some of these have been discussed above and others will be apparent to those skilled in the art. For example, various forms of amplification can be used to achieve the same result. Also, while the signal selector as described is preferred for its speed and bi-directionality, other devices for signal selection are also possible. What is considered important for the present invention is to provide a signal delivery matrix in combination with signal component selection and de-selection in a way that any signal components received in any port may be collectively transmitted to any other port or ports.

1. An optical switch having N switch ports for switching DWDM optical signals, said optical switch comprising:
N bidirectional signal processors, including at least one associated with each of said N ports, for splitting and combining optical signals, wherein an optical signal passing in one direction through any one of said bidirectional signal processors is split into K parallel optical signals and wherein one or more optical signals passing through any one of said bidirectional signal processors in the other direction are emitted as a single optical signal, said one direction being oriented into said switch and said other direction being oriented out of said switch;
at least K signal delivery matrices, each of said signal delivery matrices having N matrix ports and broadcasting one of said K optical signals from any one of said N matrix ports to all other of said N matrix ports; and
a plurality of bidirectional signal selectors, at least one located between each one of said bidirectional signal processors and a respective matrix port to manage the optical signals being broadcast through said switch between said N switch ports by selecting or deselecting one or more signal components from each of said K optical signals.

2. An optical switch as claimed in claim 1 wherein said bidirectional signal processors are passive splitters wherein an optical signal is divided into K informationally identical signals having a power of 1/K times an input power less any power loss arising as said optical signals pass through said signal processor.

3. An optical switch as claimed in claim 1 wherein said bidirectional signal processors are active splitters including a power amplifier wherein each of said split signals has a power equal to a predetermined power.

4. An optical switch as claimed in claim 3 wherein said power amplification is sufficient to permit each of said K signals to have a power similar to an input power level.

5. An optical switch as claimed in claim 3 wherein said power amplification is provided by an erbium doped amplifier.

6. An optical switch as claimed in claim 1 wherein said bidirectional signal selectors select and deselect predetermined wavelengths.

7. An optical switch as claimed in claim 1 wherein said bidirectional signal selectors include a means for demultiplexing and multiplexing said DWDM optical signals.

8. An optical switch as claimed in claim 1 further including a control system for controlling said bidirectional signal selectors.

9. An optical switch as claimed in claim 8 wherein said control system receives control information from a network, and utilizes said control information to control said bidirectional signal selectors.

10. An optical switch as claimed in claim 9 wherein said control information includes information about one or more of polarization, power and wavelength.

11. An optical switch as claimed in claim 8 wherein said control system includes a set of desired signal properties against which measured signal properties may be compared.

12. An optical switch as claimed in claim 1 wherein each of said K signal delivery matrices comprises:
a symmetrical signal splitter having three connections associated with each of said N matrix ports wherein an input signal received by any one connection is split into two equal and parallel signals each of which passes out of said symmetrical signal splitter through the remaining two connections, and
a means for bidirectionally amplifying optical power interposed between each of said symmetrical splitters for boosting a power of each of said split signals as said split signals pass through the optical amplifier to get to the next matrix port sufficiently to substantially equal a power of an input signal received by said symmetrical splitter.

13. An optical switch as claimed in claim 12 wherein said bidirectional signal processors are active splitters including an optical amplifier wherein each of said split signals has a power equal to a predetermined power.

14. An optical switch as claimed in claim 13 wherein said power amplification is sufficient to permit each of said K signals to have a power similar to an input power level.

15. An optical switch as claimed in claim 13 wherein said power amplification is achieved by an erbium doped optical amplifier.

16. An optical switch as claimed in claim 12 wherein said bidirectional signal selectors select and deselect predetermined wavelengths.

17. An optical switch as claimed in claim 12 further including a control system for controlling said bidirectional signal selectors.

18. An optical switch as claimed in claim 17 wherein said control system receives control information from a network, and utilizes said control information to control said bidirectional signal selectors.

19. An optical switch as claimed in claim 18 wherein said control information includes information about one or more of polarization, power and wavelength.

20. An optical switch as claimed in claim 18 wherein said control system includes a set of desired signal properties against which measured signal properties may be compared.

21. An optical switch as claimed in claim 1 wherein each of said K signal delivery matrices comprises:
at least one second bidirectional signal processor for splitting and combining optical signals associated with each of said bidirectional signal selectors, wherein an optical signal passing in one direction through said bidirectional signal processors is split into (N-1) parallel signals and wherein one or more optical signals passing through said bidirectional signal processor in the other direction are emitted as a single signal, said one direction being oriented into said matrix and said other direction being oriented out of said matrix;
an optical connection for each of said (N-1) signals between each of said second bidirectional signal processors and each other matrix port; and
a first optical amplifier associated with said switch to amplify a power of the optical signals being switched by a predetermined amount.

22. An optical switch as claimed in claim 21 wherein said bidirectional signal processors are active splitters each including a second optical amplifier wherein each of said split signals has a power equal to a predetermined power.

23. An optical switch as claimed in claim 21 wherein said first optical amplifier is sufficient to permit each of said K signals to have a power similar to an input power level.

24. An optical switch as claimed in claim 23 wherein said first optical amplifier is achieved by an erbium doped optical amplifier.

25. An optical switch as claimed in claim 24 wherein said bidirectional signal selectors select and deselect predetermined wavelengths.

26. An optical switch as claimed in claim 21 further including a control system for controlling said bidirectional signal selectors.

27. An optical switch as claimed in claim 26 wherein said control system receives control information from a network, and utilizes said control information to control said bidirectional signal selectors.

28. An optical switch as claimed in claim 27 wherein said control information includes information about one or more of polarization, power and wavelength.

29. An optical switch as claimed in claim 26 wherein said control system includes a set of desired signal properties against which measured signal properties may be compared.

30. An optical switch as claimed in claim 1 wherein there are provided a first and second bidirectional signal selectors for each of said K signals for each of said N matrix ports and an optical signal circulator connected between each pair of bidirectional signal selectors and said N signal processors, said optical signal circulator having at least three connections and circulating an optical signal received at one connection out of the next adjacent connection on said circulator,
and wherein said signal delivery matrices further comprise a bidirectional broadcast coupler having a first side and a second side, each side having N coupler connections, one each of said coupler connections on said first side being connected to one first signal selector of each of said pair of signal selectors and one each of the connections on the second side being connected to one second signal selector of said pair of signal selectors, wherein an optical signal passing from either side of said bidirectional broadcast coupler to the other side of said bidirectional broadcast coupler is split into N parallel signals each of which is passed to each of said N matrix ports through a respective signal selector.

31. An optical switch as claimed in claim 30 wherein said bidirectional signal processors are active splitters including an optical amplifier wherein each of said split signals has a power equal to a predetermined power.

32. An optical switch as claimed in claim 30 wherein said power amplification is sufficient to permit each of said K signals to have a power similar to an input power level.

33. An optical switch as claimed in claim 32 wherein said optical amplification is achieved by an erbium doped optical amplifier.

34. An optical switch as claimed in claim 32 wherein said bidirectional signal selectors include a shutter array for selecting and deselecting predetermined wavelengths.

35. An optical switch as claimed in claim 30 further including a control system for controlling said bidirectional signal selectors.

36. An optical switch as claimed in claim 35 wherein said control system receives control information from a network, and utilizes said control information to control said bidirectional signal selectors.

37. An optical switch as claimed in claim 36 wherein said control information includes information about one or more of polarization, power and wavelength.

38. An optical switch as claimed in claim 35 wherein said control system includes a set of desired signal properties against which measured signal properties may be compared.

39. An optical switch having N switch ports comprising a switch architecture having K signal delivery matrices in which any signal received in any one of said N switch ports may be routed through any one of said K signal delivery matrices to any other of said N switch ports.

40. An optical switch having N switch ports for switching optical signals, said optical switch comprising a switch architecture connecting said N ports to permit a signal received in one of said N switch ports to be routed to any other of said N ports, and having at least one optical amplifier, wherein a signal may be switched and emitted from said switch at a predetermined power.

41. A method of switching optical signals through a switch having N switch ports comprising the steps of:
a) receiving a signal at one of said N ports; and then
b) dividing said received signal into K informationally identical signals; and then
c) selecting or deselecting signal components from one or more of said K like signals;
d) broadcasting said selected signal components to the other of said N switch ports; and
f) emitting said signals from said other N switch ports as desired.

42. A method of switching optical signals through a switch having N switch ports comprising the steps of:
a) receiving a signal at one of said N switch ports; and then
b) dividing said received signal into K informationally identical signals; and then
c) selecting or deselecting signal components from one or more of said K like signals; and then
d) providing said selected signal components to at least one other of said N switch ports; and then
e) combining said selected signal components with other selected signal components received at said one other of said N switch ports; and then
f) emitting said combined selected signal components from said one other of said N switch ports.

43. The method of claim 42 wherein each of said N ports simultaneously receives and emits signals.

44. The method of claim 42 further including a second step of selecting or deselecting said signal components at said emitting port.

45. The method of claim 42 further including a step of optically amplifying signals switched by said switch to a predetermined power level.
